(19) United States
(12) Patent Application Publication
(10) Pub. No.: US 2010/0138226 A1
(43) Pub. Date: Jun. 3, 2010

(54) Method and Arrangement for Controlling and Charging for Peer-to-Peer Services in an IP-based Communication Network

(75) Inventors: Frank-Uwe Andersen, Berlin (DE); Wolfgang Hahn, Bergfelde (DE)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO. KG, München (DE)

(21) Appl. No.: 12/063,510

(22) PCT Filed: Jul. 17, 2006
(86) PCT No.: PCT/EP06/64336

§ 371 Date: Feb. 11, 2008

(30) Foreign Application Priority Data
Aug. 10, 2005 (DE) 10 2005 037 874.9

(51) Int. Cl. G06Q 30/00; G06F 15/16

(52) U.S. Cl. 705/1.1; 709/204; 709/225

(57) ABSTRACT

A system and a method permit P2P services in an IP-based communications network and also permit direct IP-traffic between subscribers in a controlled manner solely for specific P2P applications that are predetermined by the system provider. Other aims are to provide options for carrying out a special billing method for subscribers of P2P services and to enable the detection of the termination of a P2P session of a subscriber in order to withdraw the authorization for the corresponding P2P service in the network of the system provider. The aims are achieved by software containing logic P2P service-specific communication channels in the terminals, each terminal communicating with an index server prior to establishing direct logic communication connections to other terminals in the communications system. The index server then carries out a P2P service-specific access check for each terminal in conjunction with the billing and access check control function.

The present invention relates to a method and an arrangement for controlling and charging for peer-to-peer services in an IP-based communication network in accordance with independent claims 1 and 17.

Peer-to-peer or P2P networks are network systems without central access control in which all involved terminals act with equal authority. In this case, a data link is always produced directly from one terminal to the other on a logic level without the interposition of a network server, for example. P2P technology allows the local provision of data via a network. On the Internet, P2P technology is used primarily for what is known as file sharing, where a large number of largely anonymous users interchange files such as music files, videos, program files or other electronic documents via what are known as barter exchanges.

One advantage of P2P technology is the local data management, since the data are on the participating terminals and not on one or more central servers. In addition, all the subscribers involved in P2P networks with their terminals have equal authority: any subscriber in the network can provide any other subscriber with functions and services and can also use functions and services provided by other subscribers.

Whereas P2P has become more and more established on the Internet in the form of barter exchanges and IP telephony, direct IP traffic between subscribers in a large number of mobile radio networks is not permitted. The main reason is that the subscribers would be able to bypass mechanisms for use prescribed by the mobile network operator (MNO), e.g. for sending messages or for VoIP telephone calls, in the case of direct IP links from mobile radio to mobile radio. In addition, the marketing and billing concepts of the MNO would be able to be bypassed and hence not applied.

Other reasons for blocking the P2P traffic in mobile radio networks are, inter alia, fear of viral or hacking attacks and also possible “charging attacks”, where an end subscriber can engender costs for another end subscriber by sending this other end subscriber unsolicited data packets for whose reception the other end subscriber is charged.

The P2P barter exchanges mentioned below show the type of a hybrid P2P network, in which particular functions such as content searches or searches for content providers are implemented partly or exclusively centrally. This is done using what is known as a P2P index server, for example, which indexes the contents provided by all subscribers (peers). The content data are downloaded locally via direct P2P links between the terminals of the P2P subscribers, with download from a plurality of sources simultaneously also playing a significant part. Other P2P systems are known in which all functions are implemented locally.

To implement IP-based P2P services such as barter exchanges in mobile radio networks the following problems need to be solved, inter alia:
a) The direct IP traffic between the terminals of the subscribers needs to be permitted in controlled fashion only for particular applications, for example for the barter exchanges which are provided by the MNO.
b) Optionally, it must be possible to approve a P2P service only for such subscribers as have subscribed for this P2P service with the MNO.
c) There must be opportunities to perform special and subscriber-specific charging for P2P services.
d) Optionally, it is possible to provide for charging which rewards the provision or upload of data and hence charges less than for the download of data. What are known as “incentive systems” have to date been supported only in isolated incidences and internally in P2P systems, but not by the respective operator of the service or not by the MNO.
e) In addition a P2P system in a mobile radio network needs to cope with the large number of different communication relationships which can arise just for a single download. In particular, it must be expected that requests are sent to new or other mobile P2P subscribers very frequently and in rapid succession, and loading or barter operations are initiated and particularly also the online status of the participating terminals is varied with equal frequency. In connection with P2P, the latter is also called a “Churn rate”. In contrast to that in a landline P2P, the mobile P2P churn rate is very high and represents one of the greatest problems for mobile P2P services: the P2P index server cannot identify all direct P2P links between the participating terminals because the terminals arrange these links directly with one another without informing the P2P index server. If all direct P2P links were reported to the P2P index server, a very high level of dynamic complexity would arise on account of the possible multiplicity of links for every single download operation. In addition, the direct P2P links which relate to a download operation can change in the course of the operation, for example because one of the terminals which provide the download data terminates the connection for the communication network.
f) It must be possible to establish when a subscriber's P2P session has been terminated by the P2P index server, for example, in order to cancel the relevant subscriber's authorization for the relevant P2P service in the MNO's network.

To date, no method of implementing a P2P-service in mobile radio networks is known which solves the above problems. One possible solution would be to use a special access point name (APN) for the IP traffic from mobile radio subscribers among one another. The APN is an access point (Gateway) which allows external networks to be accessed and, by way of example, WAP or Internet access to be obtained. Using an APN, however, the control function described in point a) would not be realized, through it would be possible to charge specifically for the IP traffic using this APN. Also, a special APN is not desired by the MNO on account of the additional administration complexity required. Furthermore, it would not be possible to approve other services with a destination address outside the address range of the mobile terminals in the same packet data protocol (PDP) context, such as Internet access or IMS services which are in the P2P address space, since these services have a different charging scheme than P2P services.

The object of the invention is to design a method and an arrangement which allow P2P-services in an IP-based communication network taking account of the problems illustrated in a) to f).

This object is achieved for the method by the features of claim 1 and for the arrangement by the features of claim 17.

Advantageous developments of the invention are specified in the dependent claims.

In the inventive method for controlling and charging for peer-to-peer services, P2P-services for short, in an IP-based communication network, a server system and a plurality of terminals communicate with one another in the communication network. A charging and access control regulation function is used for charging and access control for the communication traffic. Direct logical communication links, called P2P links, are used for the communication between the terminals. In addition, the software uses logical P2P-service-specific communication channels on the terminals. Each terminal communicates with the server system before setting up direct logical communication links to other terminals in the communication system. The server system performs P2P-service-specific access control for each terminal communicating with the server system in collaboration with the charging and access control function.

The invention also comprises an arrangement having means for carrying out the method presented above.

The present invention has the advantage that the inventive method of self-administration and the use of already existing APNs simplifies the implementation of a P2P-service by the MNO. Similarly, the use of the service by the subscribers is simplified: it suffices if the MNO provides client software (for example as a file download for the subscribers) and an index server. This means that only low costs arise for the MNO. Despite the low expense, the new range of services means that the MNO benefits from the increased volume of data traffic. In this context, the contents are produced and distributed by the subscribers themselves.

In one advantageous form of the invention, the access control performed by the server system and the charging and access control regulation function takes place on the basis of a previously granted P2P-service-specific authorization.

In another advantageous form of the invention, for subscriber-specific and terminal-specific distinction and control of the P2P-service-specific service data streams an IP traffic processing function is used at an access node in the communication network.

In another advantageous form of the invention, a charging and access control regulation function is used for charging and access control for the communication traffic.

In another advantageous form of the invention, the server system uses an interface to interchange terminal-specific and subscriber-specific information with the charging and access control regulation function.

In another advantageous form of the invention, the charging and access control regulation function generates P2P-service-specific charging rules on the basis of the information received from the server system.

In another advantageous form of the invention, the charging and access control regulation function checks, on a subscriber-specific basis, whether a previously granted P2P-service-specific authorization is in place.

In another advantageous form of the invention, the P2P-service-specific charging rules generated by the charging and access control regulation function are loaded into the IP traffic processing function of the access node.

In another advantageous form of the invention, the P2P-service-specific charging rules generated by the charging and access control regulation function are used for terminal-specific charging and access control for the communication traffic.

In another advantageous form of the invention, each terminal notifies the server system of its data available locally for download.

In another advantageous form of the invention, each terminal receives from the server system information about data available for download on other terminals.

In another advantageous form of the invention, the charging and access control regulation function provides a terminal with direct P2P links to other terminals in a communication network for a prescribed period as part of the subscriber-specific P2P-service-specific access control.

In another advantageous form of the invention, the charging and access control regulation function denies a terminal direct P2P links to other terminals in a communication network as part of the subscriber-specific P2P-service-specific access control.

In another advantageous form of the invention, the server system checks the P2P-service-specific activity of each terminal previously approved for direct logical P2P links by the server system at prescribed intervals and extends the access grant for direct logical P2P links for each active terminal by a prescribed period.

In another advantageous form of the invention, the server system and the charging and access control regulation function deny direct logical P2P links to terminals which have not performed any P2P-service-specific actions over a determined period.

In another advantageous form of the invention, terminals which the server system has allowed direct logical P2P links set up direct logical P2P links to other terminals which are likewise authorized for direct logical P2P links, and are able to interchange data with these authorized terminals.

The invention is illustrated below using an exemplary embodiment and with reference to the appended drawings, in which:

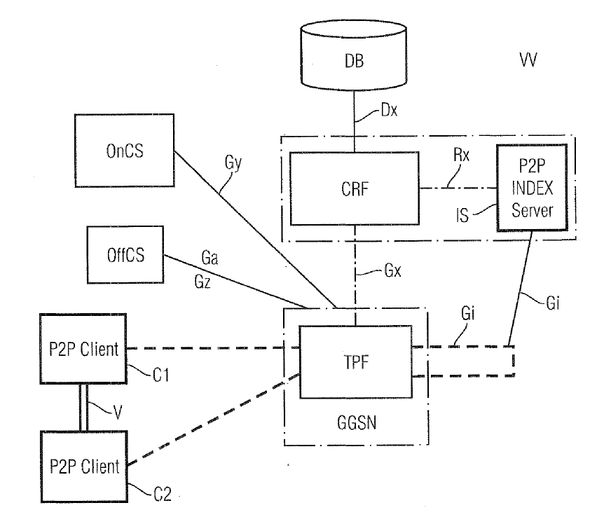

FIG. 1 shows a mobile radio communication system having two terminals C1, C2 as P2P clients.

FIG. 1 shows an exemplary embodiment of the inventive method and the arrangement for controlling and charging for P2P-services in IP-based communication networks. The exemplary embodiment relates to a mobile 3GPP communication network belonging to an MNO. The invention can be applied to any type of IP-based communication network, however, for example to a landline network.

In the exemplary embodiment shown in FIG. 1, the access node GGSN (gateway GPRS Support Node) contains the IP traffic processing function TPF: as soon as a terminal C1, C2 sets up an IP link via the interface Gi to the Internet, the IP traffic processing function TPF can distinguish different service data streams within this IP link on the basis of packet filters. By way of example, the TPF can approve certain IP traffic or reject IP packets on a specific basis. In addition, the TPF can be used in order to count the volume of data or the time of an IP link, for example in order to deliver this information to an offline charging system OffCS via particular interfaces Ga, Gz. In the case of an online charging system OnCS, the TPF can detect the calculated volume or the calculated time from a time or data volume which applies to a particular group of service data streams by communicating with the online charging system OnCS via the interface Gy.

In the exemplary embodiment, the access node GGSN is provided as an example of an access node in a 3GPP mobile radio network. In other access networks, similar access nodes are conceivable, for example access gateways or access servers.

The TPF can be regarded as what is known as a policy enforcement point which enforces the decision of the control elements IS and CRF, which are yet to be explained below, by opening or closing the useful channel data streams. To allow the TPF to distinguish the different service data streams, the invention makes the following extensions to the P2P applications which are installed on the terminals C1, C2 and are based on the prior art:

The P2P client software installed on the terminals C1, C2, sends and receives P2P data streams exclusively on an MNO-specific port number. In this context, a port number is a number which explicitly indicates the software within the communication network to which a data packet needs to be transmitted for a terminal. Advantageously, this is the port number from the header in an IP packet or another piece of information which every IP packet contains, for example. In this way, the P2P-specific service data streams of the terminals C1, C2 involved can be distinguished from other service data streams by the TPF. This is a prerequisite for P2P-service-specific charging, as proposed in line with the invention.

The service data streams are produced by P2P links V between the terminals C1, C2. These P2P links are logical links between the terminals whose physical counterpart Gi always runs through a network access node GGSN in the communication network of the MNO.

FIG. 1 also shows the charging and access control regulation function CRF: the CRF stores the charging rules, in particular. Charging rules stipulate how the different service data streams are handled by the TPF. In this context, a fundamental part of a charging rule is a packet filter, which contains parameters for describing and identifying service data streams, in the present case IP data streams. In line with the invention, the parameters relate to IP addresses and port numbers. Other parameters are conceivable. Charging rules stipulate, on the basis of these parameters, the form of charging for the IP data streams in question. Examples of possible charging forms are online charging using an online charging system OnCS or offline charging using an offline charge system OffCS, and also volume-dependent and/or time-dependent charging.

If a terminal C1, C2 wishes to obtain access to the Internet at a particular access node GGSN, the CRF loads the relevant P2P-service-specific charging rules into the TPF via the interface Gx. When the P2P-service-specific charging rules have been loaded into the TPF of the GGSN, the P2P-service-specific service data streams produced by the terminals C1, C2 can be charged for and controlled.

In line with the invention, every participating terminal C1, C2 must make contact with a P2P index server IS, which indexes the contents provided by all subscribers on their terminals C1, C2, in order to announce data released for download and/or to request downloadable data. As FIG. 1 shows, the CRF has an interface Rx to the P2P index server IS. This interface Rx is used to interchange control parameters, such as dynamic IP addresses for the terminals C1, C2, which are known only to the P2P index server IS.

The CRF and the IS may advantageously be represented by an arrangement VV. The CRF and the IS may also have their functions implemented on separate systems.

In line with the invention, the interface Rx between the CRF and the index server IS is used to grant the terminals C1, C2 access to the P2P service and in this way to exercise access control through the CRF. In respect of this access control, the following cases may arise:
1. If subscribes have used their terminals C1, C2 to register (subscribe) with the MNO for the P2P service at an earlier time, the CRF receives the appropriate subscription information via an interface Dx to a database DB which stores the MNO's subscriber database.
2. Participating terminals C1, C2 use the MNO's P2P index server IS. Advantageously, this so-called self-administration is implemented by virtue of the subscribers having previously installed the appropriate client software provided by the MNO for P2P services, for example as a download, on their terminals.
3. Both criteria 1. and 2. apply simultaneously.

In case 1, during connection setup from the terminals C1, C2 to the communication network of the MNO (setting up the PDP context, gaining Internet access), the CRF loads a P2P-service-specific charging rule in the GGSN's TPF, which admits the IP traffic from the terminals C1, C2 to other terminals C1, C2 in the MNO's communication network in a particular IP address range with the stipulated port numbers of the P2P service. According to standard, there is no appropriate P2P-service-specific charging rule active in the TPF, which means that P2P-service-specific IP traffic is rejected in the TPF (access control function). In line with the invention, the TPF therefore denies terminals C1, C2 access to the P2P service if the relevant subscribers have not previously registered with the MNO for the P2P service and the CRF have therefore not loaded a rule into the TPF which would have allowed the terminals C1, C2 to access the P2P service.

In case 2, a participating terminal C1, C2 contacts the MNO's P2P index server IS as part of its IP context which has already been set up. The P2P index server IS is situated in an address range for MNO services and can therefore be reached by any participating terminal C1, C2 in the MNO's communication network. Alternatively, there is a rule active in the TPF which admits the traffic from the terminals C1, C2 to the server system IS in general. When contact has been made, the P2P index server IS uses the interface Rx to send the CRF the information relating to the P2P-service-specific port numbers and the IP address of the contacting terminals C1, C2. The CRF takes this information as a basis for generating a P2P-service-specific charging rule and loads this rule into the GGSN's TPF via the interface Gx. From this time onward, the generated P2P-service-specific charging rule allows the P2P-service-specific IP traffic in the TPF. Case 2 can be referred to as self-administration of the terminals C1, C2.

In case 3, the CRF, having received the information transmitted by the P2P index server IS, additionally checks whether a subscriber whose terminal C1, C2 contacts the P2P index server is registered for the MNO's P2P service.

If a terminal C1, C2 is a “roaming” subscriber from another communication network belonging to an alien MNO, the CRF can deny access to the MNO's P2P service in order to prevent such a terminal C1, C2 from having the advantage of special charging, for example.

Following successful access to the MNO's P2P service via terminals C1, C2, the P2P index server IS performs a P2P-service-specific access control function: when a terminal C1, C2 has access to the P2P index server IS, the P2P index server IS allows the terminal C1, C2 to access the MNO's P2P service and to set up direct logical P2P links V to other terminals C1, C2 in the network for a prescribed period. This period is extended by the P2P index server IS if the P2P index server detects P2P-service-specific activity from the terminal C1, C2. To check the P2P-service-specific activity of a terminal C1, C2, the P2P index server IS collects presence information about the terminals C1, C2. This can be done by checking the activity of the terminals C1, C2 on the P2P index server IS, for example (for example checking upon requests for the availability of particular data for download from other terminals C1, C2 and/or announcing the local availability of particular data for download). Examples of other possibilities are direct demand on a terminal C1, C2 participating in the P2P service in order to detect the P2P service specific activity of the terminal C1, C2 or definition of a P2P presence session in which a terminal C1, C2 is registered with the P2P index server IS and reports its local data to the P2P index server IS.

If the P2P index server IS does not detect any P2P-service-specific activity by a terminal C1, C2 over a relatively long period, it uses the interface Rx to inform the CRF, which then uses the interface Gx to prompt removal of the relevant P2P-service-specific charging rule from the TPF in order to deny the relevant terminal C1, C2 further access to the P2P service. This allows abuse of the MNO's P2P service to be restricted.

The server system IS and the charging and access control function CRF make a decision at the control level, which can also be referred to as a policy decision.

The following possibilities exist, inter alia, for charging for the P2P service:
It is possible to charge for the P2P-service-specific IP traffic in the same way as normal Internet traffic associated with the MNO. In this case, the function of the described method is primarily to grant P2P-service-specific IP traffic.
The P2P-service-specific IP traffic can cost less than the normal communication traffic of the MNO: the MNO does not need to provide any Internet access, since all of the P2P-service-specific IP traffic is routed via direct logical P2P links in its own network. This can make an overall positive contribution to increasing the volume of data traffic in the communication network. In addition, two terminals C1, C2 are involved on every direct logical P2P link.
The charging can be levied by the MNO on the basis of volume of IP packets or duration of the direct logical P2P links.
For the P2P-service-specific IP traffic, uploading can be cheaper or free, for example. Hence, that subscriber on a direct P2P link who is downloading would bear the total costs of the relevant direct logical P2P link (session). In this way, it would be possible to reward and encourage the provision of data for download.

1-17. (canceled)

18. A method for controlling and charging for peer-to-peer services, P2P-services for short, in an IP-based communication network, which comprises the steps of:
providing a server system for communicating with a plurality of terminals in the communication network;
using a charging and access control regulation function for charging and access control for communication traffic;
using direct logical communication links, called P2P links, for communication between the terminals;
providing software which uses logical P2P-service-specific communication channels on the terminals;
communicating via each terminal with the server system, before setting up direct logical communication links to other terminals in the communication network; and
performing, via the server system, P2P-service-specific access control for each terminal communicating with the server system in collaboration with the charging and access control regulation function.

19. The method according to claim 18, which further comprises performing access control performed by the server system and the charging and access control regulation function on a basis of a previously granted P2P-service-specific authorization.

20. The method according to claim 18, which further comprises using for subscriber-specific and terminal-specific distinction and control of P2P-service-specific service data streams, an IP traffic processing function at an access node in the communication network.

21. The method according to claim 18, which further comprises using the charging and access control regulation function for charging and access control of the communication traffic.

22. The method according to claim 18, which further comprises providing an interface where the server system uses the interface to interchange subscriber-specific and terminal-specific information with the charging and access control regulation function.

23. The method according to claim 18, which further comprises generating via the charging and access control regulation function, P2P-service-specific charging rules on a basis of information received from the server system.

24. The method according to claim 18, which further comprises using the charging and access control regulation function to check, on a subscriber-specific basis, whether a previously granted P2P-service-specific authorization is in place.

25. The method according to claim 18, which further comprises loading the P2P-service-specific charging rules generated by the charging and access control regulation function into an IP traffic processing function of an access node.

26. The method according to claim 18, which further comprises using P2P-service-specific charging rules generated by the charging and access control regulation function for subscriber-specific and terminal-specific charging and access control for the communication traffic.

27. The method according to claim 18, wherein each of the terminals notifies the server system of its data available locally for download.

28. The method according to claim 18, wherein each of the terminals receives from the server system information about data available for download on other terminals.

29. The method according to claim 18, wherein the charging and access control regulation function provides a terminal with direct logical P2P links to other terminals in a communication network for a prescribed period as part of subscriber-specific P2P-service-specific access control.

30. The method according to claim 18, which further comprises using the charging and access control regulation function to deny a terminal direct logical P2P links to other terminals in the communication network as part of subscriber-specific P2P-service-specific access control if no P2P-service-specific authorization has previously been granted.

31. The method according to claim 18, which further comprises using the server system to check the P2P-service-specific activity of each of the terminals previously approved for direct logical P2P links by the server system at prescribed intervals and extending an access grant for direct logical P2P links for each active terminal by a prescribed period.

32. The method according to claim 18, which further comprises using the server system and the charging and access control regulation function to deny direct logical P2P links to the terminals which have not performed any P2P-service-specific actions over a determined period.

33. The method according to claim 18, wherein the terminals which the server system has granted direct logical P2P links set up direct logical P2P links to other terminals which are likewise authorized for direct logical P2P links, and are able to interchange data with the authorized terminals.

34. A configuration for controlling and charging for peer-to-peer services, P2P-service for short, in an IP-based communication network, the configuration comprising:
a server system;
means for communicating between said server system and a plurality of terminals in the communication network;
a charging and access control regulation function for charging and access control of communication traffic;
means for the terminals to communicate with one another via direct logical communication links, called P2P links;
software-based logical P2P-service-specific communication channels on the terminals;
means for each terminal to communicate with said server system before direct logical communication links have been set up to other terminals in the communication network; and
means for said server system to perform P2P-service-specific access control for each terminal communicating with said server system in collaboration with the charging and access control regulation function.
